(19) United States
(12) Patent Application Publication
(10) Pub. No.: US 2026/0046705 A1
(43) Pub. Date: Feb. 12, 2026

(54) MEASUREMENT EVENT CONFIGURATION FOR ENABLING L1/2 MOBILITY AND MEASUREMENT REPORTING USING MAC CE

(71) Applicant: InterDigital Patent Holdings, Inc., Wilmington, DE (US)

(72) Inventors: Brian Martin, Farnham (GB); Oumer Teyeb, Montreal (CA); Martino Freda, Laval (CA); Paul Marinier, Brossard (CA); Keiichi Kubota, Setagaya-Ku (JP)

(73) Assignee: InterDigital Patent Holdings, Inc., Wilmington, DE (US)

(21) Appl. No.: 18/998,580

(22) PCT Filed: Jul. 31, 2023
(86) PCT No.: PCT/US2023/071303

§ 371 Date: Jan. 27, 2025

Related U.S. Application Data
(60) Provisional application No. 63/395,240, filed on Aug. 4, 2022.

(51) Int. Cl. H04W 36/00

(52) U.S. Cl. CPC H04W 36/0058

(57) ABSTRACT

A wireless transmit/receive unit (WTRU) configured to receive a radio resource control (RRC) message comprising an indication of channel configuration information for one or more candidate cells associated with inter-cell mobility, perform the measurement on each of the candidate cells within the subset of the one or more candidate cells, determine whether the event trigger criteria is met by each of the candidate cells within the subset of the one or more candidate cells; and send a second L1/L2 control message comprising an indication of whether the event trigger criteria is met for each of the candidate cells within the subset of the one or more candidate cells and the associated measurement value for each of the candidate cells within the subset.

### CROSS-REFERENCE TO RELATED APPLICATIONS

This application claims the benefit of U.S. Provisional Application No. 63/395,240 , filed on Aug. 4, 2022, the entire contents of which are incorporated herein by reference.

### BACKGROUND

Mobility based on L1/L2 indications may be implemented by a WTRU sending an RRC measurement report and a CU making the mobility decision and informing a DU to send a corresponding L1/L2 indication. However, this implementation may not enable latency reduction. Therefore, what is needed are mechanisms that enable the network to trigger L1/L2 mobility without involving RRC measurement and reporting to the CU. This disclosure pertains to devices, methods, and systems for measurement event configurations for enabling L1/2 mobility and measurement reporting.

### SUMMARY

A WTRU may be configured with enhanced measurement and reporting configurations to allow for relative signal level comparisons between serving cells, including between an SCell and a SpCell, two SCells, and multiple SCells and a PCell. A wireless transmit/receive unit (WTRU) may comprise a processor. The processor may be configured to receive a radio resource control (RRC) message comprising an indication of channel configuration information for one or more candidate cells associated with inter-cell mobility, an index for identifying the one or more candidate cells, and an event trigger criteria for performing measurement evaluation of the one or more candidate cells. The processor may be further configured to receive a first layer 1 or layer 2 (L1/L2) control message comprising an indication that the WTRU is to activate a measurement on a subset of the one or more candidate cells. The processor may be further configured to perform the measurement on each of the candidate cells within the subset of the one or more candidate cells, the measurement providing an associated measurement value for each of the candidate cells within the subset of the one or more candidate cells. The processor may be further configured to determine whether the event trigger criteria is met by each of the candidate cells within the subset of the one or more candidate cells based on the associated measurement value of each of the candidate cells within the one or more candidate cells. The processor may be further configured to send a second L1/L2 control message comprising an indication of whether the event trigger criteria is met for each of the candidate cells within the subset of the one or more candidate cells and the associated measurement value for each of the candidate cells within the subset of the one or more candidate cells that met the event trigger criteria.

The event trigger criteria may comprise a minimum radio quality threshold. The minimum radio quality threshold may be an absolute value compared to a special cell (SpCell) within the subset of the one or more candidate cells or a relative value compared to a special cell (SpCell) within the subset of the one or more candidate cells.

The event trigger criteria may comprise a comparison between the associated measurement value of a candidate cell selected from the subset of the one or more candidate cells and the associated measurement value of a special cell (SpCell) with the subset of the one or more candidate cells.

The event trigger criteria may comprise a comparison between an associated measurement value of a serving cell and the associated measurement value of a special cell (SpCell) within the subset of the one or more candidate cells.

The associated measurement value for each of the candidate cells within the subset of the one or more candidate cells may comprise an offset compared to the associated measurement value of a special cell (SpCell) within the subset of one or more candidate cells.

The first and second L1/L2 control messages may comprise medium access control elements (MAC CEs).

The second L 1/L2 control message may comprise a bitmap that indicates whether the event trigger criteria is met for each of the candidate cells within the subset of the one or more candidate cells.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a procedure diagram illustrating an example New Radio (NR) handover scenario.

FIG. 3 is a procedure diagram illustrating an example CHO configuration and execution.

FIG. 4 is a functional model illustrating an example L1/L2 inter-cell mobility operation using CA.

FIG. 5A illustrates an example MAC CE structure for sending measurement reports.

FIG. 5B illustrates an example mapping for absolute power measurement reporting.

FIG. 6A illustrates a further example MAC CE structure for sending measurement reports.

FIG. 6B illustrates an example mapping for absolute power measurement reporting.

FIG. 6C illustrates an example mapping for relative power measurement reporting.

FIG. 7 illustrates another example MAC CE structure for sending example measurement reports.

FIG. 8 is a procedure diagram illustrating an example message sequence.

FIG. 9 is a flow chart illustrating an example WTRU procedure for CHO configuration and execution.

### DETAILED DESCRIPTION

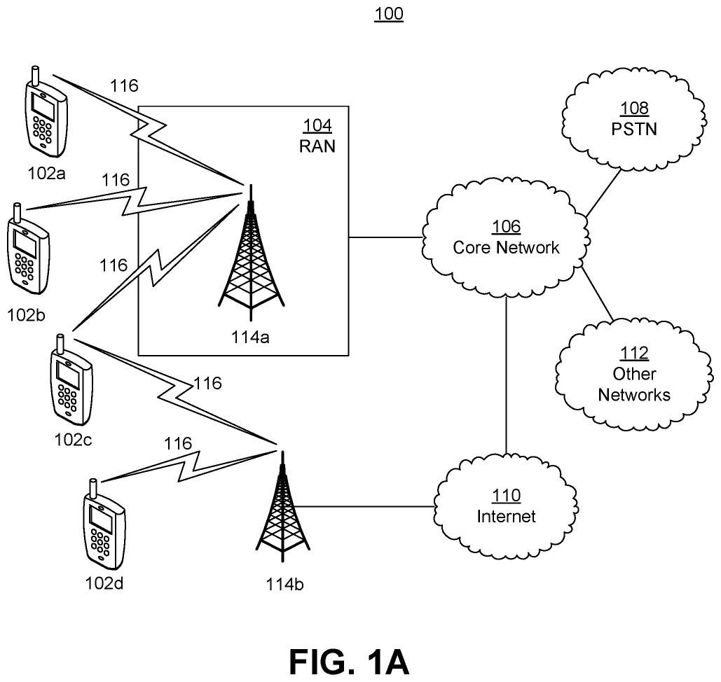

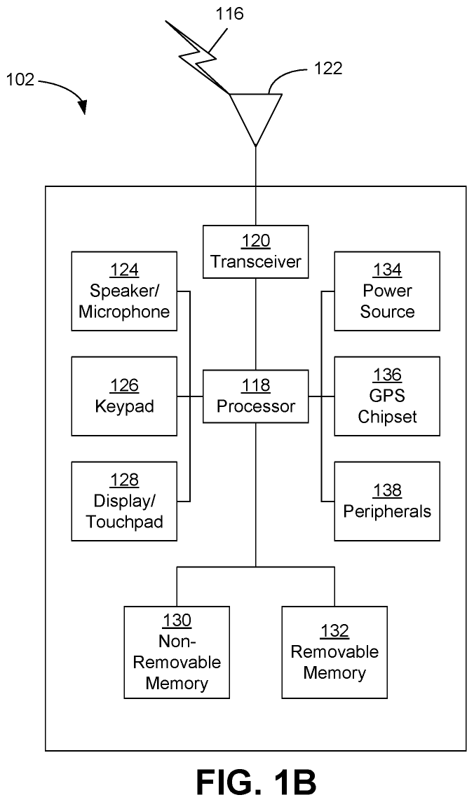

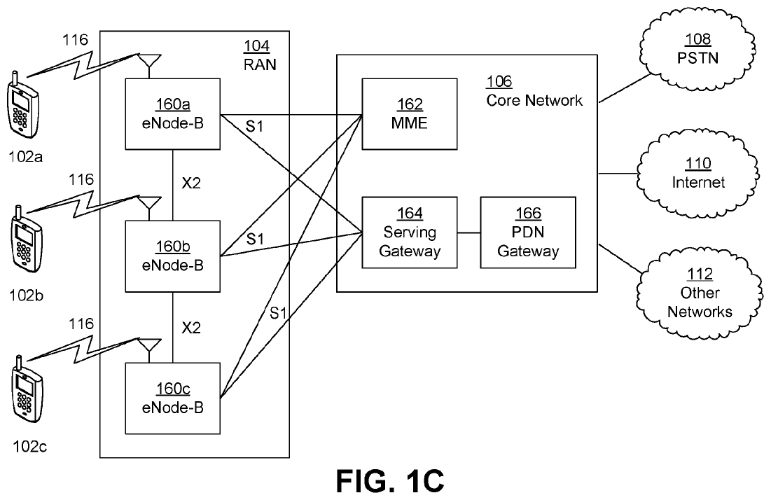

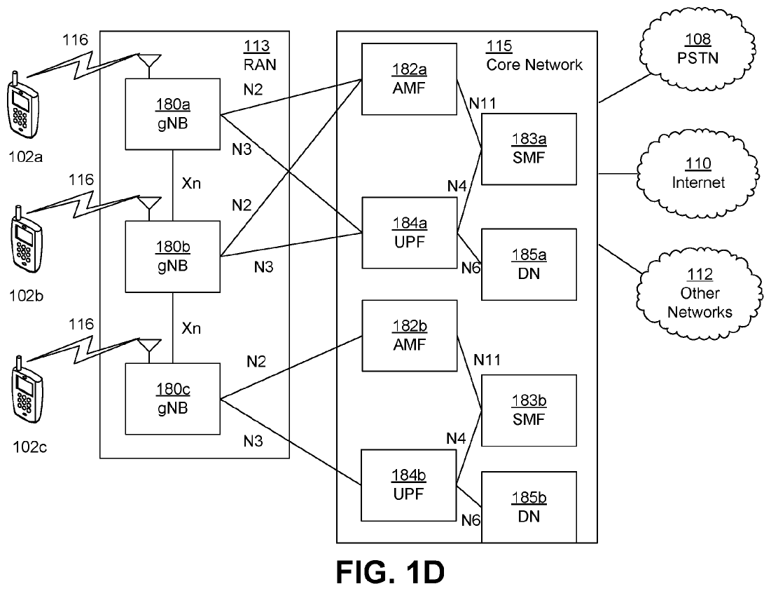

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or an “STA,” may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116, The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUS 102a, 102b, 102c, and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operation, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11 af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel that may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHZ depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b.

The SMF 183a, 183b may perform other functions, such as managing and allocating WTRU IP addresses, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

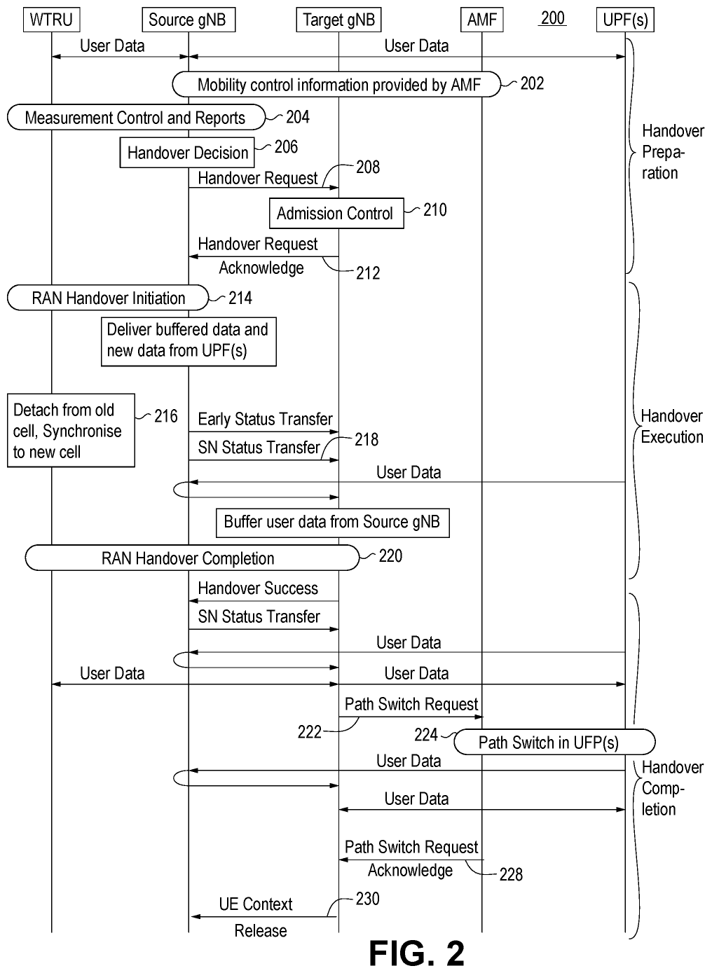

FIG. 2 is a procedure diagram 200 illustrating an example NR handover scenario. At 202, an access and mobility access function (AMF) may provide mobility control information. For a WTRU within a source gNB, the provided mobility control information may contain information regarding roaming and/or access restrictions. The information on roaming and/or access restrictions may be provided to the WTRU at a connection establishment and/or at a timing advance (TA) update.

At 204, the source gNB may configure the WTRU measurement control and report procedures and/or the WTRU may report measurements according to a measurement configuration.

At 206, the source gNB may decide to handover the WTRU based on the reported measurements.

At 208, the source gNB may issue a HANDOVER REQUEST message to a target gNB. For example, the source gNB may issue a HANDOVER REQUEST message by passing a transparent RRC container with the necessary information to prepare for the handover at the target side. The necessary information may include at least the target cell ID, KgNB*, the C-RNTI of the WTRU in the source gNB 204, RRM-configuration including WTRU inactive time, basic AS-configuration including antenna information and DL carrier frequency, the current QoS flow to DRB mapping rules applied to the WTRU, the SIB1 from source gNB, the WTRU capabilities for different RATs, PDU session related information, and/or the WTRU reported measurement information including beam-related information, if available.

At 210, the target gNB may perform admission control. If the WTRU is to be admitted, the target gNB may prepare the handover with L1/L2.

At 212, the target gNB may send a HANDOVER REQUEST ACKNOWLEDGE message to the source gNB. The HANDOVER REQUEST ACKNOWLEDGE message may include a transparent container to be sent to the WTRU as an RRC message to perform the handover.

At 214, the source gNB may trigger a Uu handover at the WTRU. For example, the source gNB may send an RRCReconfiguration message to the WTRU to initiate the Uu handover. The RRCReconfiguration message may contain the information required to access the target cell. For example, the RRCReconfiguration message may include at least the target cell ID, the new C-RNTI, and/or the target gNB security algorithm identifiers for the selected security algorithms. The RRCReconfiguration message may further include a set of dedicated RACH resources, an association between RACH resources and SSB(s), an association between RACH resources and WTRU-specific CSI-RS configuration(s), common RACH resources, and system information of the target cell.

At 216, the source gNB may send an SN STATUS TRANSFER message to the target gNB. The SN STATUS TRANSFER message to the target gNB may convey an uplink PDCP SN receiver status and/or a downlink PDCP SN transmitter status of DRBs for which PDCP status preservation applies (e.g., for RLC AM).

At 218, the WTRU may detach from the old cell (e.g., source gNB) and synchronize to the target cell (e.g., target gNB).

At 220, the WTRU may complete the RRC handover by sending an RRCReconfigurationComplete message to target gNB.

At 222, the target gNB may send a PATH SWITCH REQUEST message to AMF to trigger 5GC. The PATH SWITCH REQUEST message may be sent to trigger 5GC to switch the DL data path towards the target gNB and/or to establish an NG-C interface instance towards the target gNB.

At 224, the 5GC may switch the DL data path toward the target gNB.

At 226, the UPF may send one or more “end marker” packets on the old path to the source gNB per PDU session/tunnel and/or release any U-plane/TNL resources directed towards the source gNB.

At 228, the AMF may confirm the PATH SWITCH REQUEST message with a PATH SWITCH REQUEST ACKNOWLEDGE message.

At 230, upon reception of a PATH SWITCH REQUEST ACKNOWLEDGE message from the AMF, the target gNB may send a UE CONTEXT RELEASE message to inform the source gNB about the success of the handover. The source gNB may release radio and C-plane related resources associated with the WTRU context. Any ongoing data forwarding may continue.

NR introduced the concept of conditional handover (CHO) and conditional PSCell Addition/Change (CPA/CPC, or collectively referred to as CPAC) to help reduce the likelihood of radio link failures (RLF) and handover failures (HOF).

Legacy LTE/NR handovers are typically triggered by measurement reports. However, the network may send a HO command without a WTRU receiving a measurement report. For example, the WTRU may be configured with an Event A3 that triggers a measurement report to be sent when the radio signal level/quality (RSRP, RSRQ, etc.) of a neighbor cell becomes better than the primary serving cell (PCell). In the case of dual connectivity (DC), an Event A3 may trigger a measurement report when the RSRP of a neighboring cell becomes better than the primary secondary serving Cell (PSCell). The WTRU may monitor serving and neighboring cells and send a measurement report when conditions are fulfilled. When such a report is received, the network (e.g., the current serving node/cell) may prepare the HO command (e.g., an RRC Reconfiguration message with a reconfiguration WithSync) and send the HO command to the WTRU. The WTRU may execute the HO command immediately, resulting in the WTRU connecting to the target cell.

A CHO may differ from a legacy handover in certain operational aspects. For example, in legacy handovers, only one handover target is prepared. In a CHO, multiple handover targets may be prepared.

As another example, in legacy handovers, the handover is immediately executed. In a CHO, the handover may not be immediately executed. Instead, in a CHO, the WTRU may be configured with triggering conditions that may include a set of radio conditions. The WTRU may execute the handover towards one of the targets when one or more of the triggering conditions are fulfilled.

A CHO command may be sent when the radio conditions towards the current serving cells are favorable, reducing certain points of failure existing in legacy handovers. The points of failure may include a failure to send the measurement report (e.g., if the link quality to the current serving cell falls below acceptable levels when the measurement reports are triggered in legacy handover). The points of failure may include a failure to receive the handover command (e.g., if the link quality to the current serving cell falls below acceptable levels after the WTRU sent the measurement report but before the WTRU received the HO command).

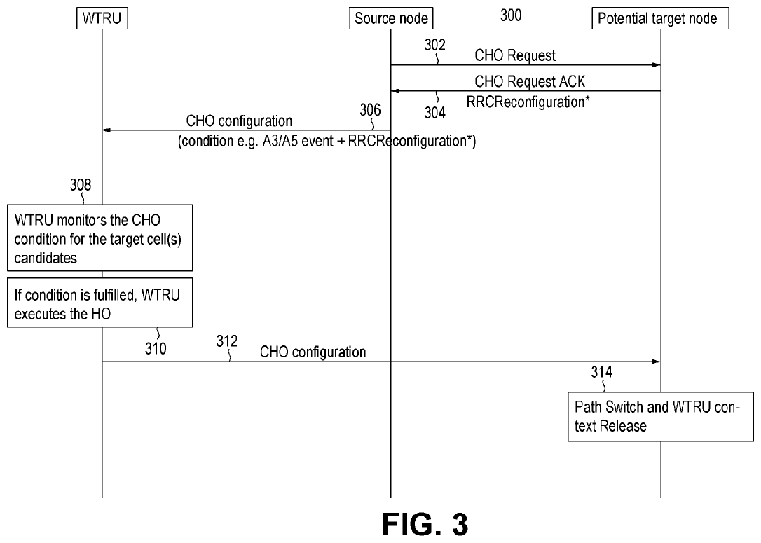

FIG. 3 is a procedure diagram 300 illustrating an example CHO configuration and execution. At 302, a source node may transmit a CHO request message to a potential target node. At 304, the target node may transmit a CHO Request ACK message to the source node. For example, the CHO Request ACK message may be an RRC Reconfiguration message.

At 306, the source node may transmit a CHO configuration message to the WTRU. For example, the CHO configuration message may include a triggering condition within an RRC Reconfiguration message. The triggering condition may include an Event A3 and/or an Event A5 triggering condition. The triggering conditions for a CHO may be based on the radio quality of the serving cells and/or neighbor cells, similar to the conditions used in legacy NR/LTE to trigger measurement reports. For example, the WTRU may be configured with a CHO with an Event A3 like triggering conditions and/or associated HO command.

At 308, the WTRU may monitor the CHO condition for target cell(s) candidates. For example, the WTRU may monitor the current cells and serving cells.

At 310, the WTRU may execute the HO command if it is determined that a triggering condition is fulfilled.

For example, when the Event A3 triggering condition is fulfilled, the WTRU may execute the HO command and switch its connection toward the target cell without sending a measurement report.

At 312, the WTRU may transmit a CHO confirmation to the target node.

At 314, the target node may perform a path switch and a WTRU context release.

In an embodiment, a CHO may prevent unnecessary re-establishments in the case of a radio link failure.

For example, for cases in which the WTRU is configured with multiple CHO targets and the WTRU experiences an RLF before triggering conditions with any target cells are fulfilled, legacy handover operations would have resulted in an RRC re-establishment procedure. This procedure may incur considerable interruption time for the bearers of the WTRU. Alternatively, after detecting an RLF, a WTRU configured with CHO may directly execute the HO command associated with a target cell that already has an associated CHO (e.g., the target cell is already prepared for handover) instead of continuing with the full re-establishment procedure.

In an embodiment, CPC and CPA may be extensions of CHO in DC scenarios. For example, a WTRU may be configured with triggering conditions for PSCell change or addition. When the triggering conditions are fulfilled, the WTRU may directly execute the associated PSCell change or PSCell add commands.

In an embodiment, the WTRU may be configured for inter-cell L1/L2 mobility. In NR Release 16 of 3GPP (R16), the WTRU may be configured to use inter-cell L1/L2 mobility to manage one or more beams in a carrier aggregation (CA) case. However, cell change or cell addition is not supported in NR Release 17 of 3 GPP (R17).

In NR Release 18 of 3 GPP (R18), one of the objectives of WI “Further NR Mobility Enhancements” in RP-213565 was to specify mechanisms and procedures of L1/L2 based inter-cell mobility for mobility latency reduction. For example, to specify mechanisms and procedures of L1/L2 based inter-cell mobility for mobility reduction, multiple candidate cells may be configured and maintained to allow fast application of configurations for candidate cells. As another example, candidate serving cells (e.g., SpCell and SCell) may include dynamic switch mechanisms for the potential applicable scenarios based on L1/L2 signaling [RAN2, RAN1]. As another example, to specify mechanisms and procedures of L1/L2 based inter-cell mobility for mobility reduction, L1 enhancements for inter-cell beam management are provided, including L1 measurement and reporting and beam indication [RAN1, RAN2]. Early RAN2 involvement may be necessary, including the possibility of further clarifying the interaction between L1 enhancements for inter-cell beam management and dynamic switch mechanisms among candidate serving cells. As another example, timing advance management may be provided to specify mechanisms and procedures of L1/L2 based inter-cell mobility for mobility reduction [RAN1, RAN2]. Further, to specify mechanisms and procedures of L1/L2 based inter-cell mobility for mobility reduction, CU-DU interface signaling to support L1/L2 mobility may be provided.

The procedure of L1/L2 based inter-cell mobility may be applicable in multiple scenarios, including standalone, CA and NR-DC cases with serving cell change within one CG; an Intra-DU case and an intra-CU inter-DU case (e.g., applicable for Standalone and CA: no new RAN interfaces are expected), both intra-frequency and inter-frequency, FR1 and FR2, and synchronized or non-synchronized source and target cells. An inter-CU may be included for the L1/L2 based inter-cell mobility procedure. FR2 specific enhancements are not precluded.

R17 includes L1/L2 based mobility and inter-cell beam management in addressed intra-DU and intra-frequency scenarios. In these scenarios, the serving cell remains unchanged (e.g., there is no possibility to change the serving cell using L1/L2 based mobility). In FR2 deployments, CA is typically used to exploit the available bandwidth, such as aggregating multiple CCs into one band. These CCs are typically transmitted with the same analog beam pair (e.g., gNB and UE beams). The WTRU may be configured with TCI states for the reception of PDCCH and PDSCH. For example, the WTRU may be configured with a relatively large number (e.g., 64) of TCI states. Each TCI state may include an RS or SSB that the WTRU may utilize to set its beam.

In R17, the SSB may be associated with a non-serving PCI. MAC signaling (e.g., “TCI state indication for WTRU-specific PDCCH MAC CE”) may activate the TCI state for a Coreset/PDCCH. Reception of PDCCH from a non-serving cell is supported by MAC CE indicating a TCI state associated to a non-serving PCI. MAC signaling (e.g., “TCI States Activation/Deactivation for WTRU-specific PDSCH”) may activate a subset of (e.g., up to) 8 TCI states for PDSCH reception. DCI may indicate which of the 8 TCI states are activated. R17 supports a “unified TCI state” with a different updating mechanism (e.g., DCI-based) but without multi-TRP. R18 supports a unified TCI state with multi-TRP.

An overall objective of L1/L2 inter-cell mobility may be to improve handover latency. In a conventional or conditional L3 handovers, the WTRU typically first sends a measurement report using RRC signaling. In response to the measurement report, the network may provide a further measurement configuration and potentially a conditional handover configuration.

In a conventional L3 handover, the network may provide a configuration for a target cell after the WTRU reports using RRC signaling to indicate that the cell meets a configured radio quality criteria. In a conditional L3 handover, the network may provide a target cell configuration and measurement criteria that determine when the WTRU should trigger the CHO configuration. These criteria may be provided in advance to help reduce the handover failure rate due to a delay in sending the measurement report and/or receiving the RRC reconfiguration. However, conventional or conditional L3 handovers may suffer from some delay due to the sending of measurement reports and the receiving of target configurations, particularly in the case of the conventional (non-conditional) handover.

A particular aim of an L1/L2 based inter-cell mobility configuration may be to allow for fast application of configurations for candidate cells, including dynamically switching between SCells and switching of PCell (e.g., switching the roles between SCell and PCell) without performing RRC signaling. However, this mobility configuration may not apply to inter-CU handovers as these may require relocation of the PDCP anchor. Therefore, an RRC based approach may still be needed to support inter-CU handovers.

In legacy L3 handover mechanisms, any currently active SCells are released before the WTRU completes the handover to a target cell in the coverage area of a new site. The released SCells may only be added back after a successful handover, leading to throughput degradation during handover. Therefore, one of the aims of L1/L2 is to enable CA operation to be enabled instantaneously upon serving cell change.

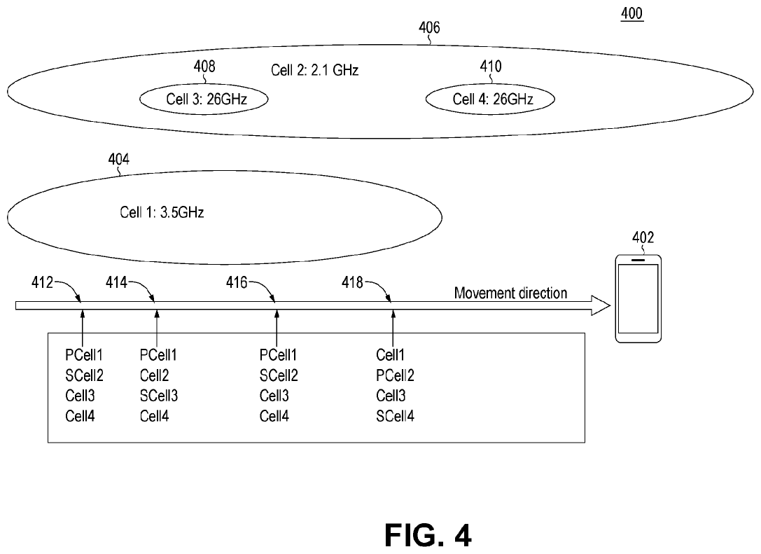

FIG. 4 is a functional model 400 illustrating an example L1/L2 inter-cell mobility operation using CA. As shown in the functional model 400, a WTRU 402 may switch between candidate cells as it physically traverses across a Cell 1 (e.g., 3.5GHz) 404, a Cell 2 (e.g., 2.1GHZ) 406, a Cell 3 (e.g., 26GHz) 408, and a Cell 4 (e.g., 26 GHZ) 410. At a first position 412, using CA, the WTRU 402 may be initially configured with Cell 1 404 as a primary cell (e.g., PCell 1) and Cell 2 408 as a secondary cell (e.g., SCell 2). At this position 412, RRC measurements and reporting may have configured Cells 1-4 404, 406, 408, 410 as candidate cells. Once configured, Cell1 404 may be activated as a primary cell and Cell2 406 activated as a secondary cell. At a second position 414, the WTRU 402 may dynamically switch its secondary cell to Cell 3 408 (e.g., SCell 3). At a third position 416, the WTRU 402 may dynamically switch its secondary cell to Cell 2 406 (e.g., SCell 2). At a fourth position 418, the WTRU 402 may dynamically switch its primary cell to Cell 2 406 (e.g., PCell 2) and its secondary cell to Cell 4 410 (e.g., SCell 4). The candidate cell group within the functional model 400 may be configured by RRC message and dynamic switching of PCells and SCells may be achieved using L1/L2 signaling.

To enable fast switching between cells (e.g., SpCells (PCell and/or PSCell)), candidate cells may be preconfigured at the RRC level such that these configurations may be applied upon receiving an indication from L1/L2 messages. The candidate cells may have a configuration for one or more candidate cells (e.g., at least one of a SpCell or SCell) which may be dynamically applied based on an indication at lower layers (e.g., L1/L2).

Mobility decisions (e.g., those related to SCell addition/removal, SCell change, SpCell change, and CHO configuration) may be based on measurement reporting (e.g., event) configurations done at the RRC level. For example, a CHO may be configured if the WTRU reports an Event A2 (e.g., serving becomes worse than a threshold). As another example, a SpCell change (e.g., HO) may be initiated based on the WTRU sending a measurement report that is triggered due to the fulfillment of an Event A3 (e.g., a neighbor becomes offset better than SpCell) or an Event A5 (e.g., SpCell becomes worse than a first threshold and neighbor becomes better than a second threshold). As another example, an SCell addition may be performed if the WTRU sends a measurement report triggered due to the fulfillment of an Event A4 (e.g., a neighbor cell becomes better than a threshold). As another example, an SCell change may be performed based on the fulfillment of an Event A6 (e.g., a neighbor cell becomes offset better than SCell).

In legacy NR operations, if a CU-DU split architecture is employed, L1 measurements are reported to the DU (e.g., CQI reports), which are suitable for scheduling purposes. Since any cell changes or reconfigurations require significant processing, cell changes or reconfigurations should not be performed too frequently based on the L1 signaling. Moreover, cell changes or reconfigurations should be performed when a stable measurement result is used for determining a reconfiguration decision. L3 measurements (e.g., measurements filtered at L3 to filter out short-term fluctuations) are thus used for making mobility decisions. The L3 measurements are sent to the CU where the RRC is terminated. Based on the L3 measurements, the CU's RRC may send reconfiguration messages instructing the WTRU to perform mobility operations (e.g., a HO command for immediate mobility, a CHO for mobility when certain conditions are fulfilled, etc.).

One way to implement mobility based on L1/L2 indications may be for the WTRU to send an RRC measurement report, for the CU to make the mobility decision, and for the CU to inform the DU to send the corresponding L 1/L2 indication. However, such an implementation may contradict one of the main objectives of L1/L2 mobility (e.g., latency reduction). As such, mechanisms may be required to enable the network to trigger the L1/L2 mobility without involving RRC level signaling (e.g., at the MAC/PHY level; at the DU in the case of a CU-DU split architecture).

In an embodiment, the WTRU may be configured to enable low latency L1/L2 mobility that does not involve RRC level signaling for both UL and DL. The WTRU may be configured with enhanced measurement reporting/event configurations that may make relative signal level comparisons between serving cells. For example, the WTRU may be configured with enhanced measurement reporting/event configurations that may make relative signal level comparisons between serving cells. The relative signal level comparisons may be between various cell types and configurations (e.g., an SCell and a SpCell, two SCells, several SCells and a PCell, all SCells and a PCell, etc.).

In an embodiment, the WTRU may be configured to enable an L1/L2 switch from an SCell to a SpCell, or vice versa. The WTRU may be configured to send concise L3 level measurements at the MAC level (e.g., MAC CE). The WTRU may be configured to enable MAC level HO decisions at the network (e.g., without involving the CU).

The WTRU may be configured for the performance of some of the mobility decisions at the DU to help reduce latency using L1/L2 mobility. For example, for an intra-DU PCell change, the DU may make the mobility decision. Therefore, latency may be significantly improved by reporting measurements (e.g., similar to those made at L3) to the DU instead of the CU, such that the DU may manage intra-DU handover. Simultaneous with reporting measurements to the DU, some L3 measurements may be reported to the CU (e.g., via RRC measurement reporting) in order for the CU to manage inter-DU or inter-CU handover. Reporting measurements at RRC implies an increased delay due to such factors as MAC and RLC retransmissions and sending reports over multiple TTIs. Accordingly, defining a more dynamic way of reporting measurements may be advantageous.

An L3 measurement event may not contain all the necessary evaluation methods needed to perform some L1/L2 triggered reconfiguration procedures. An L3 measurement reporting may be configured with a measurement identity associated with a measurement object (e.g., identifying the carrier to measure and properties of the carrier) and a report criteria (e.g., the conditions to monitor/evaluate). Defined measurement events are configured such that the WTRU compares the configured measurement object (i.e., the neighboring cell) with the serving cell. In L1/2 triggered reconfigurations, the ability to change a serving cell's role (e.g., from an SCell to a PCell, or vice versa) provides for comparing serving cells against one another. In an embodiment, the WTRU may be configured to compare candidate cells (e.g., perhaps not configured as serving cells at the moment) with serving cells and to compare neighbor cells with candidate cells.

In an embodiment, the WTRU may utilize measurement reporting methods. Moreover, the WTRU may be configured to utilize a new suite of measurement events to evaluate the criteria for performing an L1/L2 triggered reconfiguration.

In an embodiment, the WTRU may be configured with new measurement events. The measurement events may be triggered based on the WTRU comparing a serving cell (or a set of serving cells) with the current SpCell.

A measurement event may be associated with one SCell and a threshold level. For example, the WTRU may trigger the measurement report when the SCell becomes better than a SpCell by more than the configured threshold.

A measurement event may be associated with multiple SCells and a threshold level. For example, the WTRU may trigger the measurement report when one or more SCells become better than a SpCell by more than the configured threshold.

A measurement event may be associated with multiple SCells and a threshold level. For example, the WTRU may trigger the measurement report when all SCells become better than a SpCell by more than the configured threshold.

A measurement event may be associated with multiple SCells and a threshold level. For example, the WTRU may trigger the measurement report when a certain number of the SCells become better than SpCell by more than a configured threshold. The certain number of SCells may be associated with the event.

A measurement event may be associated with multiple SCells and one threshold level. For example, the WTRU may trigger the measurement report when a certain percentage (e.g., configured within the event) of the SCells becomes better than a SpCell by more than one threshold level.

A measurement event may include a combination of one or more configurations of measurement reports, and a threshold level may be unique or different for each SCell.

In an embodiment, the measurement event configuration may contain absolute threshold levels associated with the SpCell, serving cells, and/or candidate cells. For example, the measurement event may be associated with one SCell and one threshold level. The WTRU may trigger the measurement report when the SCell becomes better than the one threshold level.

The measurement event may be associated with multiple SCells and one threshold level. For example, the WTRU may trigger the measurement report when one or more of the SCells becomes better than the one threshold level.

The measurement event may be associated with multiple SCells and one threshold level. For example, the WTRU may trigger the measurement report when all of the SCells become better than the one threshold level.

The measurement event may be associated with multiple SCells and one threshold level. For example, the WTRU may trigger the measurement report when a certain number of the SCells become better than the one threshold level. The certain number of SCells may be associated with the event.

The measurement event may be associated with multiple SCells and one threshold level. For example, the WTRU may trigger the measurement report when a certain percentage of the SCells become better than the one threshold level. The certain percentage of SCells may be associated with the measurement event.

A measurement may include a combination of one or more configurations of measurement reports, and a threshold level may be unique or different for each SCell.

In an embodiment, measurement event configurations may be associated with periodic reporting. For example, for relative thresholds, the WTRU may trigger the measurement report periodically, indicating which ones of the SCells are better than SpCell by more than a configured absolute relative threshold. For absolute thresholds, the WTRU may trigger the measurement report periodically, indicating which of the SCells is better than a configured absolute threshold.

The WTRU may be configured to perform periodic reporting, in which the WTRU indicates the best N serving cells (e.g., the SpCell and N-1 best SCells, the best N cells regardless of the cells being SpCell or SCell, and like combinations).

In an embodiment, the WTRU may be configured to send a measurement report that indicates the best N serving cells that fulfill a certain absolute threshold (e.g., the SpCell and N-1 best SCells, the best N cells regardless

### Of the Cells Being Spcell or Scell, and Like Combinations).

The WTRU may be configured to send the measurement report periodically or when the WTRU detects that N cells fulfill the conditions. The WTRU may be configured to perform periodic reporting that indicates the best N cells that fulfill a certain relative threshold as compared to the SpCell (e.g., the SpCell and N-1 best SCells, the best N cells regardless of the cells being SpCell or SCell, and like combinations). The WTRU may be configured to send the measurement report periodically or when the WTRU detects that N cells fulfill the conditions.

In an embodiment, one or more measurement event solutions may be applied to SCells, a candidate cell, or a set of candidate cells.

In an embodiment, the WTRU may be configured for measurement reporting using a MAC CE. The WTRU may be configured to send the measurement reports that are triggered based on an event configuration using a regular RRC measurement report. Alternatively or additionally, the WTRU may be configured to send the measurement reports that are triggered based on an event/reporting configuration using a MAC CE (e.g., using any of the example solutions discussed below).

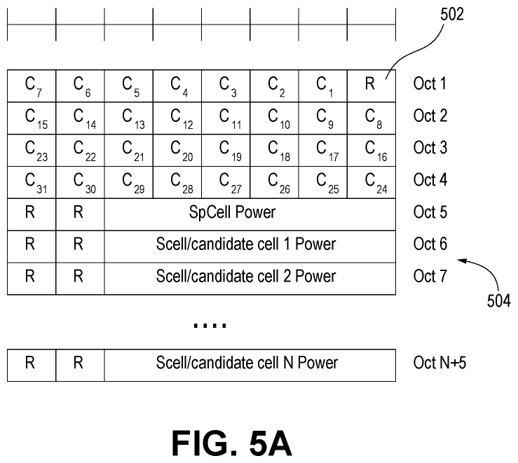

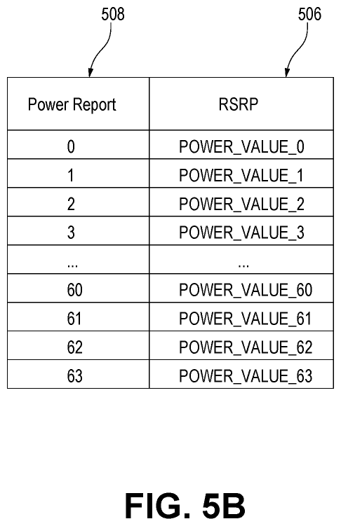

FIG. 5A illustrates an example MAC CE bitmap 500A for sending measurement reports. The bitmap 500A may be configured to indicate which candidate cells or/and serving cells are being reported. In an embodiment, each bit 502 of the bitmap 500A may correspond to an index configured in RRC, including, for example, a servingCellIndex, a SCellIndex, or a new index such as candidateCellIndex.

A ‘1’ bit 502 may indicate that measurement results for the cell are included. For example, a ‘1’ bit 502 may indicate that this cell measurement is above an absolute threshold associated with an event configuration. The threshold may be configured by RRC or may be pre-defined. A ‘1’ bit 502 may further indicate that the cell measurement is above a relative threshold (e.g., the cell measurement is within X dB of the SpCell). A ‘1’ bit 502 may further indicate that a cell has triggered a particular measurement event.

In an embodiment, the WTRU may be configured to report up to N best cells (e.g., a ‘1’ may be signaled for the best ranked N cells based on cell measurements) 504. Similarly, the WTRU may be configured to report up to N best cells that are above a threshold (e.g., a ‘1’ may be signaled for up to N cells).

In an embodiment, the MAC CE may contain a simple bitmap or identifier (e.g., an index) that conveys which cells meet certain criteria (e.g., to minimize reporting overhead). Alternatively or additionally, measurement results may be included in the MAC CE for some or all of the cells indicated in the bitmap (e.g., to improve the report accuracy). For example, the WTRU may include a measurement result for every cell indicated as ‘1’ in the bitmap.

FIG. 5B illustrates an example mapping 500B for absolute power measurement reporting. The example mapping 500B may include absolute RSRP values (e.g., measurement results) 506 and corresponding power report values 508. For example, the measurement result 506 itself may be in an abbreviated form 508, such as one of 64 values which may be defined to correspond to a power level. The WTRU may report a value corresponding to the highest power value supported by the cell measurement. For example, if there are values for −90 dB and −95 dB and the WTRU measures −92 dB, then the WTRU may report the value corresponding to −95 dB.

In an embodiment, the order of the measurement results may correspond to the order of the cell indexes within the MAC CE bitmap, which have been indicated with ‘1’. In such a configuration, the SpCell measurement may be included such that the network may compare the candidate cell results with the SpCell.

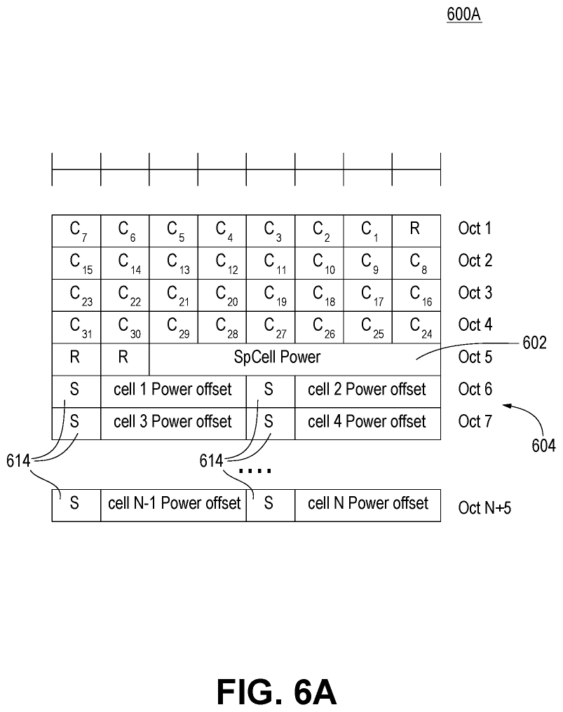

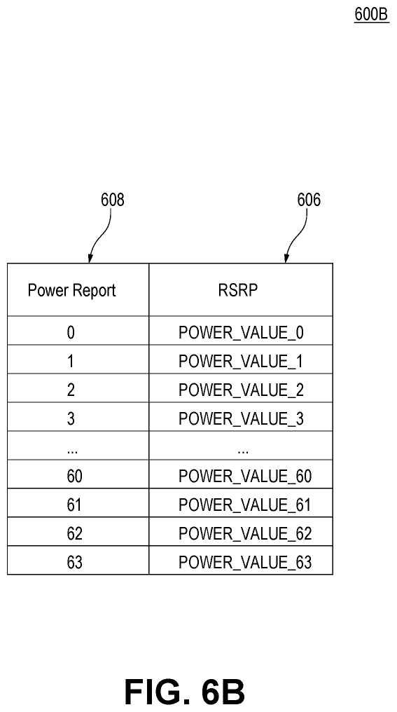

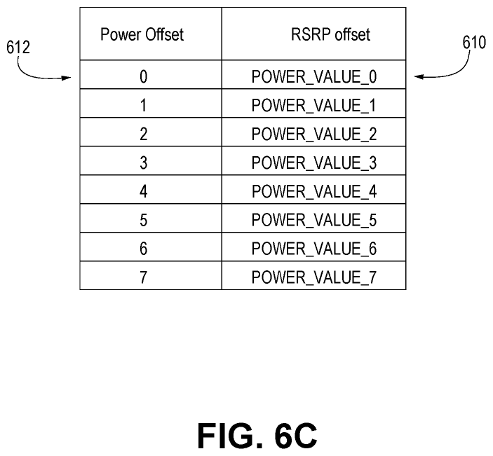

FIG. 6A illustrates another example MAC CE bitmap 600A for sending measurement reports. The bitmap 600A may be configured with the SpCell measurement result 602 reported as an absolute power, while the measurement results of other cells 604 may be reported as a relative power (e.g., offsets from the SpCell measurement). The bitmap 600A configuration may enable reporting of more cells using less bits.

In an embodiment, the WTRU may use one bit 614 (e.g., “S” bit) to indicate whether the offset is positive or negative compared to the SpCell 602, and the remaining 3 bits in this report may, for example, correspond to 7 values.

FIG. 6B illustrates an example mapping 600B for absolute power measurement reporting. The example mapping 600B may include absolute RSRP values (e.g., measurement results) 606 and corresponding power report values 608. For example, the measurement result 606 itself may be in an abbreviated form 608, such as one of 64 values which may be defined to correspond to a power level.

FIG. 6C illustrates an example mapping 600C for relative power measurement reporting. The example mapping 600C may include RSRP offset values 610 and corresponding power offset report values 612. For example, the relative power 610 may be conveyed with a smaller range of possible reported values 612 and, therefore, the reporting of more cells using fewer bits.

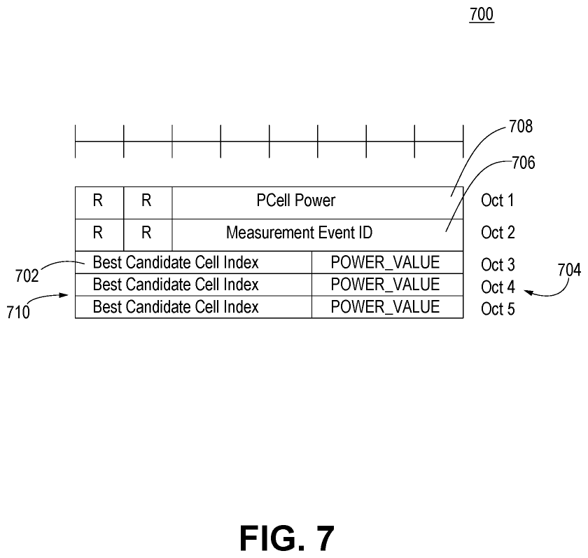

FIG. 7 illustrates another example MAC CE mapping 700 for sending example measurement reports. In an embodiment, the WTRU may indicate a “1” for all cells meeting a pre-defined criteria, such as an absolute power threshold. The WTRU may include results only for the best N cells. The WTRU may be configured to include a measurement event identifier.

As shown in FIG. 7, the MAC CE mapping 700 may include a cell index 702 and a power value 704. The MAC CE may include an identifier corresponding to a measurement identity or measurement event ID 706. For example, a measurement Event A3 may be configured for a particular candidate cell. The measurement event may be triggered when the candidate cell becomes better than the SpCell. The measurement event ID 706 may identify the candidate cell that triggered the event, or an additional indicator may be included to identify which specific cell triggered the event. Along with the indication that the event has been triggered, the WTRU may include measurement results for one or more of the PCell 708, the cell triggering the event 704, and the next N best cells 710.

In L1/L2 triggered mobility, the WTRU may be configured to change the roles between SpCell and SCell. In an embodiment, a new type of measurement event that compares serving cells (e.g., SCell and SpCell) may be required. For example, the measurement event may be triggered when an SCell becomes better than a SpCell or an SCell becomes better than SpCell by an offset. In current RRC measurement events, a WTRU may be configured to compare neighbor cells with serving cells. In some cases, the WTRU may not compare serving cells against each other.

In an embodiment, the WTRU may receive a DL MAC CE, which activates measurements for a particular set of cells or requests a report for a particular set of cells. In response, the WTRU may perform measurements and send a report using one or more formats, referring to an index of the set of cells indicated in the DL MAC CE. For example, the DL MAC CE may indicate a subset (e.g., 8) of cells from a total (e.g., 32) list of candidate cells. The WTRU may send the results (e.g., for the subset of cells; 8 cells) in the uplink corresponding to the cells indicated in the DL.

In an embodiment, the measurement report in the MAC CE may correspond to a cell configuration. For example, the report may include a SpCell identity. Moreover, the report may include the SpCell identity based on this cell being the best cell or on this cell having triggered a particular event.

In an embodiment, the report may include one or more SCell identities. For example, the report may include one or more SCell identities based on these cells being the next N best cells or on these cells meeting a second or another criteria.

In an embodiment, the network may respond with a confirmation in the downlink. For example, a confirmation in the downlink that is a MAC CE “activating” the WTRU suggested configuration. Accordingly, based on the configured criteria, the WTRU may select which cells should be activated as serving cells and what the role of these cells should be.

In an embodiment, after reporting which cells should be activated to the network, the network may either confirm using a truncated MAC CE activation command or provide an alternative configuration in a more explicit MAC CE command. For example, the network may choose a serving cell configuration that is different from the WTRU reported configuration, the network choice being based on one or more factors (e.g., load, interference, etc.).

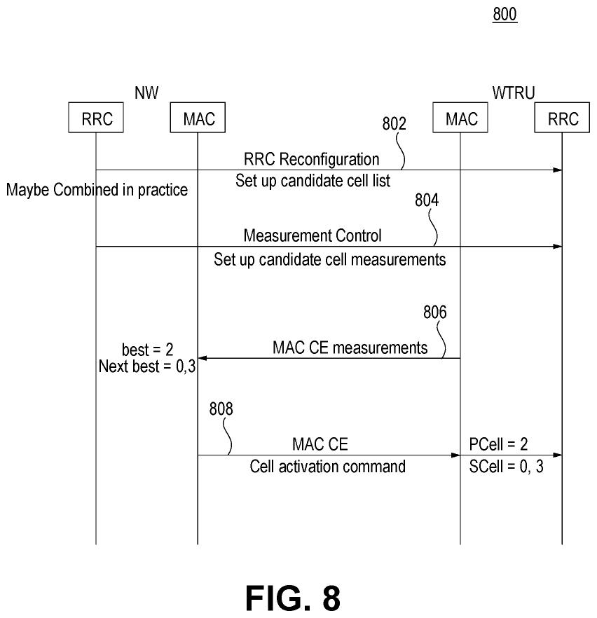

FIG. 8 is a procedure diagram 800 illustrating an example message sequence.

A network may configure a set of candidate cells and measurement reporting identities for MAC based measurement reporting and MAC triggered reconfiguration. The candidate cell setup and measurement control may be configured using independent messages. The candidate cell setup and measurement control may be performed in a single configuration message. The measurements may be enabled based on an RRC configuration alone. The measurements may be further activated or requested using a MAC CE.

As shown in FIG. 8, at 802, the NW may provide an RRC configuration to a WTRU. In an embodiment, the RRC configuration information may indicate a list of one or more candidate cells.

At 804, the NW may provide measurement control to the WTRU. The measurement control may include candidate cell measurements. The WTRU may perform measurements and evaluations based on configured criteria defined in the provided measurement control. The WTRU may trigger a MAC CE measurement report when the configured criteria is met. For example, the WTRU may determine that a configured criteria is met when a particular measurement event is triggered, measurements become available, or in response to a request.

At 806, the WTRU may report the MAC CE measurements to the NW. For example, the WTRU may report cell 2 as the best cell (or the preferred PCell) and cells 0 and 3 as the next best cells (or preferred SCells).

At 808, the NW may confirm or activate the configuration based on the WTRU report. For example, the NW may provide the MAC CE Cell activation command to the WTRU, and the NW may activate cell 2 as PCell and cells 0 and 3 as SCells.

In an embodiment, the NW may advantageously split the mobility decisions between DU and CU. The DU may manage cell changes within the DU (i.e., intra-DU) based on measurements reported at the MAC layer. The DU may activate the RRC reconfigurations for cell changes with commands sent at the MAC layer. At the same time, the CU may utilize the conventional RRC measurement reporting and reconfiguration for the management of mobility across different DUs (inter-DU). Alternatively or additionally, the DU may report the MAC measurements to the CU for the CU to perform mobility management similar to the L3 mobility performed in a conventional handover procedure.

The embodiments disclosed herein provide a method for reporting fast measurement events and cell measurements for the purpose of the network making handover and cell reconfiguration decisions. The embodiments discussed herein support the fast triggering of candidate cell role changes in the downlink.

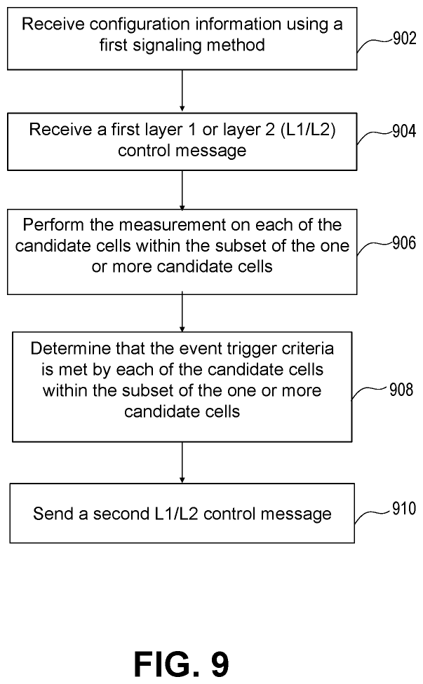

FIG. 9 is a flow chart 900 illustrating an example WTRU procedure for CHO configuration and execution. At 902, the WTRU receives configuration information using a first signaling method. For example, the first signaling method may be RRC messaging.

In an embodiment, the configuration information may comprise channel configuration information of one or more candidate cells for performing L1/L2 mobility. The configuration information may further include an index for identifying the one or more candidate cells. The configuration information may further include an event trigger criteria for performing measurement evaluations on the one or more candidate cells. The event trigger criteria may comprise a single event trigger criteria applied to all of the one or more candidate cells. Alternatively or additionally, the event trigger criteria may comprise individual trigger event criteria defined for each of the one or more candidate cells.

At 904, the WTRU receives a first layer 1 or layer 2 (L1/L2) control message. The control message may comprise an indication that the WTRU is to activate measurements on a subset of the one or more candidate cells.

At 906, the WTRU performs the measurement on each of the candidate cells within the subset of the one or more candidate cells. The measurement of the candidate cells providing an associated measurement value for each of the candidate cells within the subset of the one or more candidate cells.

At 908, the WTRU determines that the event trigger criteria is met by each of the candidate cells within the subset of the one or more candidate cells The determination may be based on the associated measurement value of each of the candidate cells within the one or more candidate cells.

At 910, the WTRU sends a second L1/L2 control message. The control message comprising an indication of whether the event trigger criteria is met for each of the candidate cells within the subset of the one or more candidate cells and the associated measurement value for each of the candidate cells within the subset of the one or more candidate cells that met the event trigger criteria.

What is claimed is:

1. A wireless transmit/receive unit (WTRU) comprising:
a processor configured to:
receive a radio resource control (RRC) message comprising an indication of channel configuration information for one or more candidate cells associated with inter-cell mobility, an index for identifying the one or more candidate cells, and an event trigger criteria for measuring the one or more candidate cells; determine that the event trigger criteria is met by at least one candidate cell of the one or more candidate cells based on a measurement of the at least one candidate cell of the one or more candidate cells; and
send a layer 1 or layer 2 control message comprising an indication of the at least one candidate cell of the one or more candidate cells.

2. The WTRU of claim 1, wherein the event trigger criteria comprises a minimum radio quality threshold.

3. The WTRU of claim 2, wherein the minimum radio quality threshold is an absolute value compared to a special cell (SpCell) of the one or more candidate cells or a relative value compared to a special cell (SpCell) of the one or more candidate cells.

4. The WTRU of claim 1, wherein the event trigger criteria comprises a comparison between an associated measurement value of a candidate cell selected from the one or more candidate cells and an associated measurement value of a special cell (SpCell) of the one or more candidate cells.

5. The WTRU of claim 1, wherein the processor is further configured to:
determine a measurement of a serving cell, the measurement providing an associated measurement value for the serving cell; and
determine whether the event trigger criteria is met by comparing the associated measurement value of the serving cell and an associated measurement value of a special cell (SpCell) of the one or more candidate cells.

6. The WTRU of claim 1, wherein the processor is further configured to:
perform measurements of a plurality of serving cells, the measurements providing an associated measurement value for at least one serving cell of the plurality of serving cells; and
determine whether the event trigger criteria is met by comparing the associated measurement value of the at least one serving cell of the plurality of serving cells and an associated measurement value of a special cell (SpCell) of the one or more candidate cells.

7. The WTRU of claim 1, wherein the processor is configured to determine an associated measurement value for at least one candidate cell of the one or more candidate cells, wherein the associated measurement value comprises an offset from an associated measurement value of a special cell (SpCell) of the one or more candidate cells.

8. The WTRU of claim 1, wherein the L1/L2 control message comprises a medium access control element (MAC CE).

9. The WTRU of claim 8, wherein the L1/L2 control message comprises a bitmap that indicates whether the event trigger criteria is met for at least one candidate cell of the one or more candidate cells.

10. A method implemented by a wireless transmit/receive unit (WTRU), the method comprising:
receiving a radio resource control (RRC) message comprising an indication of channel configuration information for one or more candidate cells associated with inter-cell mobility, an index for identifying the one or more candidate cells, and an event trigger criteria for measuring of the one or more candidate cells;
determining that the event trigger criteria is met by at least one candidate cell of the one or more candidate cells based on a measurement of the at least one candidate cell of the one or more candidate cells; and
sending a layer 1 or layer 2 (L1/L2) second L1/L2 control message comprising an indication of the at least one candidate cell of the one or more candidate cells. candidate

11. The method of claim 10, wherein the event trigger criteria comprises a minimum radio quality threshold.

12. The method of claim 11, wherein the minimum radio quality threshold is an absolute value compared to a special cell (SpCell) of the one or more candidate cells or a relative value compared to a special cell (SpCell) of the one or more candidate cells.

13. The method of claim 10, wherein the event trigger criteria comprises a comparison between an associated measurement value of a candidate cell selected from the one or more candidate cells and an associated measurement value of a special cell (SpCell) of the one or more candidate cells

14. The method of claim 10, further comprising:
determining a measurement of a serving cell, the measurement providing an associated measurement value for the serving cell; and
determining whether the event trigger criteria is met by comparing the associated measurement value of the serving cell and an associated measurement value of a special cell (SpCell) of the one or more candidate cells.

15. The method of claim 10, further comprising:
performing measurements of a plurality of serving cells, the measurements providing an associated measurement value for at least one serving cell each of the plurality of serving cells; and
determining whether the event trigger criteria is met by comparing the associated measurement value of the at least one serving cell of the plurality of serving cells and an associated measurement value of a special cell (SpCell) of the one or more candidate cells.

16. The method of claim 10, further comprising determining an associated measurement value for at least one candidate cell of the one or more candidate cells, wherein the associated measurement value comprises an offset from the measurement value of a special cell (SpCell) of the one or more candidate cells.

17. The method of claim 10, wherein the L1/L2 control message comprises a medium access control element (MAC CE).

18. The method of claim 17, wherein the L1/L2 control message comprises a bitmap that indicates whether the event trigger criteria is met for at least one candidate cell of the one or more candidate cells.

19. A wireless transmit/receive unit comprising:
a processor, wherein the processor is configured to:
receive a second L1/L2 control message comprising an indication that the WTRU is to activate a measurement on a subset of the one or more candidate cells;
perform the measurement on each of the candidate cells within the subset of the one or more candidate cells, the measurement providing an associated measurement value for each of the candidate cells within the subset of the one or more candidate cells;
determine whether the event trigger criteria is met by each of the candidate cells within the subset of the one or more candidate cells based on the associated measurement value of each of the candidate cells within the one or more candidate cells; and
send a third L1/L2 control message comprising an indication of whether the event trigger criteria is met for each of the candidate cells within the subset of the one or more candidate cells and the associated measurement value for each of the candidate cells within the subset of the one or more candidate cells that met the event trigger criteria.

20. The WTRU of claim 1, further comprising:
performing the measurement on each of the candidate cells within the subset of the one or more candidate cells, the measurement providing an associated measurement value for each of the candidate cells within the subset of the one or more candidate cells.
